(19) United States
(12) Patent Application Publication
(10) Pub. No.: US 2013/0008767 A1
(43) Pub. Date: Jan. 10, 2013

(54) ANTI-NEWTON RING SHEET, PRODUCTION METHOD THEREFOR, AND TOUCH PANEL USING THE SAME

(76) Inventor: Takehiro Sasaki, Saitama (JP)

(21) Appl. No.: 13/635,420

(22) PCT Filed: Mar. 11, 2011
(86) PCT No.: PCT/JP2011/055788

§ 371 Date: Sep. 15, 2012

(30) Foreign Application Priority Data
Mar. 29, 2010 (JP) 2010-074462

(51) Int. Cl. B32B 3/30; B29C 65/14; B29C 35/08; H01H 1/10

(52) U.S. Cl. 200/512; 428/156; 428/172; 264/496

(57) ABSTRACT

An anti-newton ring sheet is provided with an uneven layer. The uneven layer is formed by tightly arranging a plurality of structures in a lattice-like formation. The structures are substantially formed with a polymer resin and have a peak. Here, the axis extending in the vertical direction when the sheet is viewed in plan is the x-axis, and the axis extending in an orthogonal direction to the x-axis is the y-axis. In addition, an arbitrarily defined structure from the structures forming the uneven layer is a base structure, and structures that are adjacent to the base structure along the x-axis and the y-axis are other structures. The uneven layer is formed in a manner such that the height of a vertical section along the direction (x-direction, y-direction) of straight lines connecting the peak of the base structure and the peaks of the other structures periodically changes.

This application is a U.S. national phase filing under 35 U.S.C. §371 of PCT Application. No. PCT/JP2011/055788, filed on Mar. 11, 2011, and claims priority under 35 U.S.C. §119 to Japanese patent application no. 2010-074462, filed Mar. 29, 2010, the entireties of both which are incorporated herein by reference.

### TECHNICAL FIELD

The present invention relates to an anti-newton ring sheet that is suitably applicable to a touch panel or the like used on various kinds of display screens such as particularly a CRT and an FPD, and relates to a touch panel including the same.

### BACKGROUND ART

An anti-newton ring sheet has been known that prevents, when the sheet is integrated in a touch panel, the occurrence of the newton's rings phenomenon and even the occurrence of a glare phenomenon called sparkle by providing a surface of the sheet with an uneven shape of a desired size through molding (Patent Documents 1 and 2).

### RELATED ART REFERENCE

### Patent Documents

Patent Document 1: JP-A-2004-362406 (Scope of Claims)
Patent Document 2: JP-A-2005-18726 (Scope of Claims)

### SUMMARY

In view of the progress in colorization of various displays including a CRT, an FPD, and the like and the increase in definition of the colors, both the prevention of the newton's rings phenomenon and the prevention of the glare phenomenon cannot be achieved just by providing the surface of the sheet with the uneven shape of a desired size through molding. Moreover, in the case of using the anti-newton ring sheet for a touch panel, the durability was not enough to resist repeated touching (press).

According to an aspect of the present invention, there are provided an anti-newton ring sheet with high durability, which prevents newton's rings and prevents glare even in various kinds of displays with higher definition, and a touch panel using the same.

The present inventor has accomplished the present invention by discovering that a sheet with a surface having a particular uneven shape formed through molding prevents both newton's rings and glare and also has high durability.

More specifically, an anti-newton ring sheet according to the present invention includes an uneven layer in a particular shape. This uneven layer is formed substantially with a polymer resin by arranging a plurality of structures with peaks in a lattice-like formation. Here, when the anti-newton ring sheet of the present invention is viewed in plan, an axis extending in one arrangement direction of the structures is referred to as an “x axis” while an axis extending in a direction orthogonal to this x axis is referred to as an “y axis”. Moreover, an arbitrarily defined structure from among all the structures forming the uneven layer is referred to as a “base structure” and the adjacent structures on the both axes (x axis and y axis) starting from this base structure are referred to as “other structures”.

The present invention is characterized in that under such a condition, the height of a vertical section of the uneven layer periodically changes along a direction of a straight line connecting the peak of the base structure and the peaks of the other structures.

In the present invention, the change period of the height of the uneven layer is preferably set in the range of 25 μm to 1000 μm. In the present invention, the peak height of each structure is preferably set in the range of 0.8 μm to 20 μm.

In the present invention, the absolute value of an intersection angle at a position where a bottom surface of a structure intersects with any point on a ridge line of the structure is preferably set within 4 degrees.

In the present invention, each structure forming the uneven layer may contain various additives such as a microparticle as long as the structure is substantially formed with a polymer resin. Note that the microparticle described herein refers to a particle having a particle diameter at a nanometer (nm) level, and a particle having a particle diameter at a micrometer (μm) level is excluded. In the present invention, the structure is preferably formed with only the polymer resin without such a microparticle (the one having a particle diameter at a nanometer level).

An anti-newton ring sheet according to the present invention is preferably provided with a hard coat layer on a surface opposite to the surface provided with the uneven layer. In a method for producing such an anti-newton ring sheet including the uneven layer and the hard coat layer, an ionizing radiation curable resin may be used as the resin included in both the uneven layer and the hard coat layer, and while one of the layers is half-cured, the other layer may be formed and then, the both layers may be collectively cured completely.

A touch panel according to the present invention is of a resistance film type formed by disposing a pair of panel plates having conductive films so that the conductive films face each other via a spacer, which is characterized in that one or both of the conductive films are formed on a surface of the anti-newton ring sheet according to the present invention, which is provided with the uneven layer.

In the fields of photoengraving, liquid crystal, optical devices, and the like, a phenomenon called newton's rings has occurred due to close contact between members such as plastic films and glass plates. The newton's rings can be prevented by, when the members are brought into close contact with each other, keeping at least a certain space between the both members. Therefore, an anti-newton ring sheet has been proposed in which an anti-newton ring layer including a binder component and a microparticle is formed on a member through application of a coating liquid and drying and one or both surfaces of the member are subjected to unevenness forming processing. However, as a result of the progress in colorization of a CRT, an FPD, and the like, as well as the increase in definition of the colors of various kinds of displays, the use of such a conventional anti-newton ring sheet for a touch panel has led to a problem that light of a light source is refracted in an unintended direction due to a convex shape formed by the microparticle in the anti-newton ring layer to cause a glare phenomenon called sparkle, resulting in glares on the color screen with higher definition.

In view of this, recently, the anti-newton ring sheet has been proposed in which the surface of the sheet is provided with the uneven shape of a desired size through molding, as described above. However, due to the further progress in colorization of various kinds of displays such as a CRT and an FPD and the increase in definition of the colors, both the anti-newton ring property phenomenon and the anti-glare property phenomenon cannot be achieved just by providing the surface of the sheet with the uneven shape of a desired size through molding. Moreover, in the case of applying this structure to a touch panel, the durability was not enough to resist repeated pressing.

According to the anti-newton ring sheet of the present invention having the above structure, the anti-newton ring property is excellent, as well as sparkle is unlikely to occur and glare is less visually prominent on a color screen even when it is used for a touch panel including a color display with higher definition. Since the anti-newton ring sheet according to the present invention has the above structure, both the anti-newton ring property and the anti-glare property can be achieved, and further has high durability.

According to the touch panel of the present invention including the anti-newton ring sheet with the above structure, sparkle does not occur and glare on a color screen does not occur; as a result, the visibility in a front-face direction can be improved. Since the anti-newton ring sheet to be used has higher durability, the durable period of the entire device including the touch panel can be extended, which is very efficient industrially.

### BRIEF DESCRIPTION OF THE DRAWINGS

FIG. 1 is a plan view of an anti-newton ring sheet according to one embodiment of the present invention.

FIG. 2 is a three-view including a front view and a right side view in addition to the plan view of FIG. 1.

FIG. 3 is a sectional view taken along a line a-a of FIG. 1 (line parallel to the x axis passing through a peak Pb of a structure 2b in an uneven layer 3).

FIG. 4 is a sectional view of an anti-newton ring sheet according to another embodiment, which is taken along a line a-a of FIG. 2.

FIG. 5 is a sectional view of an anti-newton ring sheet according to another embodiment, which is taken along a line a-a of FIG. 2.

FIG. 6 is a sectional view of a touch panel according to one embodiment of the present invention.

FIG. 7 is a sectional view of an anti-newton ring uneven pattern according to another embodiment, which can be used for the touch panel of FIG. 6.

### DESCRIPTION OF NUMERICAL NOTATIONS

1, 1b, and 1c . . . anti-newton ring sheet, 1a . . . anti-newton ring uneven pattern, 2 . . . structure, 3 . . . uneven layer, 4 . . . support, 5 . . . base layer, 50 . . . touch panel, 52 . . . upper electrode substrate, 522 . . . upper transparent substrate (panel plate), 524 . . . upper transparent conductive film (conductive film), 54 . . . lower electrode substrate, 542 . . . lower transparent substrate (panel plate), 544 . . . lower transparent conductive film (conductive film), 56 and 58 . . . spacer, 7 . . . adhesive layer, and 9 . . . display element.

### EXEMPLARY MODE FOR CARRYING OUT THE DISCLOSED SUBJECT MATTER

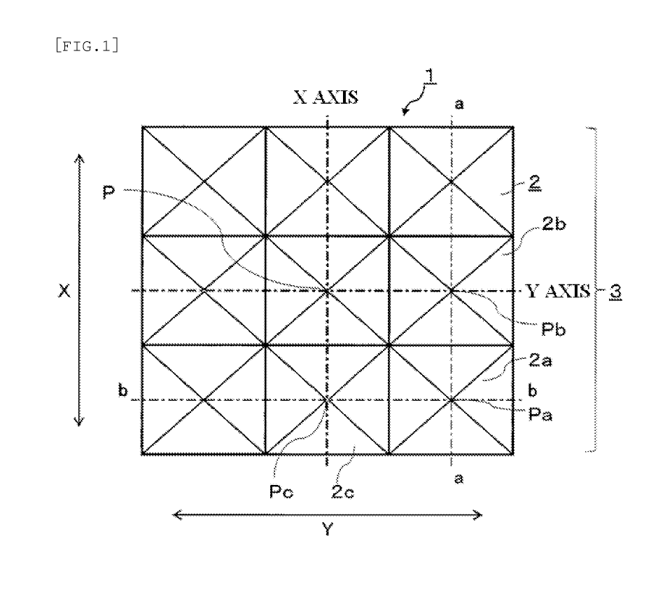

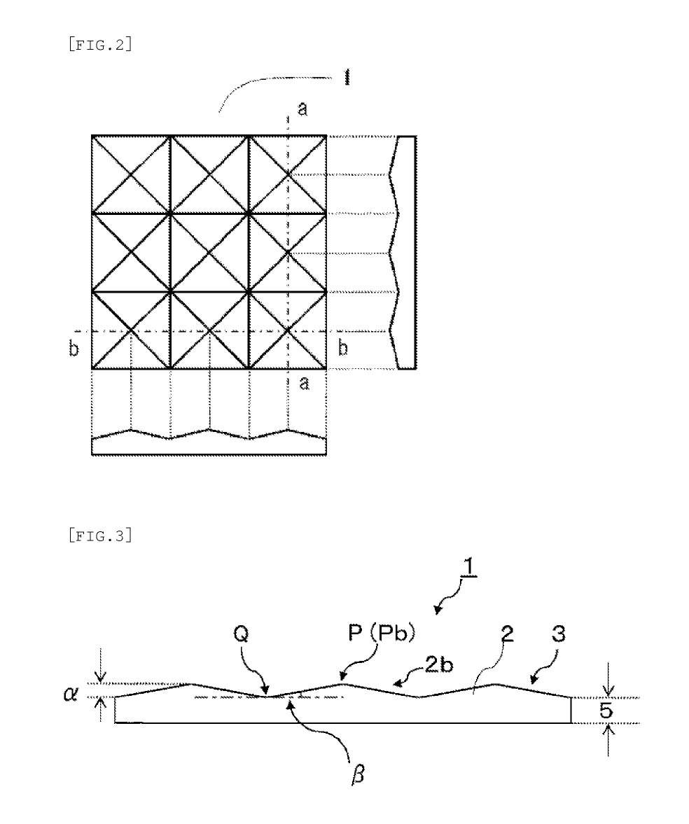

First, an embodiment of an anti-newton ring sheet of the present invention will be described. As depicted in FIG. 1 to FIG. 3, an anti-newton ring sheet 1 according to one embodiment of the present invention has a single-layer structure, and includes an uneven layer 3 shaped in a base layer 5 itself. This uneven layer 3 is formed by arranging a plurality of structures 2 in a lattice-like formation without any space. The structure 2 is substantially formed with a polymer resin, and has a peak P.

Here, an axis extending in a vertical direction (x direction in FIG. 1, an example of “one arrangement direction of the structures) when the sheet 1 is seen in plan (see FIG. 1) is referred to as an “x axis”, and an axis extending in a direction orthogonal to the x axis (y direction in FIG. 1) is referred to as a y axis. An arbitrarily defined structure from among all the structures 2 forming the uneven layer 3 is referred to as a “base structure 2a”, and adjacent structures on the both axes (x axis and y axis) starting from the base structure 2a are referred to as “other structures 2b and 2c”.

In this case, the uneven layer 3 of this embodiment is formed so that the height of a vertical section thereof changes periodically along a direction of a straight line (corresponding to x direction and y direction) connecting a peak Pa of the base structure 2a and peaks Pb and Pc of the other structures 2b and 2c. Here, the height of the vertical section means a vertical distance from the bottom part of the structure 2. The “height of the vertical section” at the position of the peak P corresponds to the distance denoted by reference sign α of FIG. 3.

The anti-newton ring sheet 1 according to this embodiment includes, first, the uneven layer 3 formed by arranging a plurality of structures 2 substantially formed with a polymer resin. Therefore, it is possible to prevent glare that has occurred in the conventional anti-newton ring sheet due to the convex shape of the microparticle with a particle diameter at a micrometer level.

Secondly, the uneven layer 3 is formed so that the height of the vertical section changes periodically along the direction of the straight line connecting the peak Pa of the base structure 2a and the peaks Pb and Pc of the other structures 2b and 2c. In this state, portions scatter, which are in contact with the members that face a surface (surface of the uneven layer 3) having the structures 2, 2a, 2b, and 2c of the anti-newton ring sheet 1. This state can prevent the occurrence of newton's rings effectively.

Thirdly, the uneven layer 3 is formed by arranging the plural structures 2 in a lattice-like formation without any space. As a result, the stability of the structure of the anti-newton ring sheet can be increased and the durability thereof can be increased.

The uneven layer 3 of the anti-newton ring sheet 1 of this embodiment is formed by arranging the structures 2 in a lattice-like formation without any space; therefore, even though a crack or foreign matter or the like with a diameter of approximately 10 to 100 μm is caused on or is attached to the anti-newton ring sheet 1, there can be obtained an effect of making the crack, the foreign matter, or the like difficult to be seen because of the shape of the surface of the uneven layer 3. Moreover, the lattice-like formation allows the convenient use of the anti-newton ring sheet 1 regardless of the vertical and horizontal directions of the structure 2.

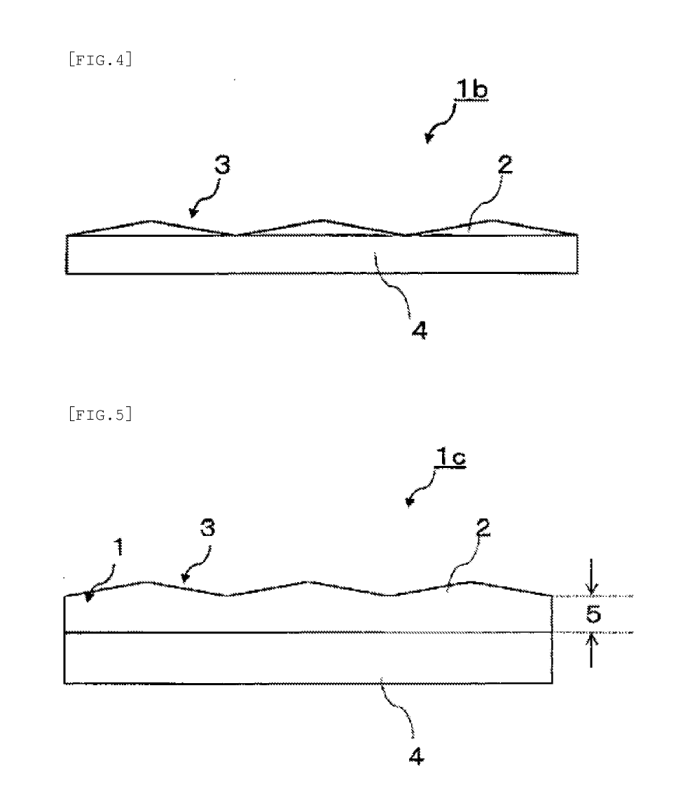

Note that although FIG. 1 to FIG. 3 show the example of the single-layer structure in which the uneven layer 3 is shaped in the base layer 5 itself, the anti-newton ring sheet of the present invention is not limited to this structure. For example, as depicted in FIG. 4, there may be employed an anti-newton ring sheet 1b with a laminated-layer structure in which the uneven layer 3 formed by arranging the plurality of structures 2 in a lattice-like formation is stacked on a surface of a support 4. Alternatively, as depicted in FIG. 5, there may be employed an anti-newton ring sheet 1c in which the anti-newton ring sheet 1 with the single-layer structure depicted in FIGS. 1 to 3 is stacked on a surface of the support 4.

The structure 2 forming the uneven layer 3 can be formed mainly with a polymer resin. The uneven layer of the conventional anti-newton ring sheet used to be formed by adding a microparticle or the like having a particle diameter at a micrometer level to a polymer resin. In contrast, in this embodiment, only the polymer resin is used without the microparticle because the uneven layer 3 is formed by a shape transfer technique typified by a 2P method, a 2T method, an embossing processing method, or the like.

By forming the anti-newton ring sheet without using the microparticle, the occurrence of glare called sparkle can be prevented when the sheet is used as a member of a touch panel simply because the sheet does not include any microparticle. Moreover, the uneven layer is formed not by the microparticle but by the shape transfer technique; therefore, the increase in internal and external haze values can be suppressed and the transparency can be improved as compared with the conventional anti-newton ring sheet. As aforementioned, in the case where the uneven layer 3 formed by arranging the plurality of structures 2 is formed on the base layer 5 (see FIGS. 3 and 5), the base layer 5 can also be formed with such a polymer resin.

Examples of the polymer resin include an ionizing radiation curable resin, a thermosetting resin, a thermoplastic resin, and a moisture curable resin. In the case of forming the structure 2 by the 2P method, the ionizing radiation curable resin is used; in the case of forming the structure 2 by the 2T method or the emboss processing method, the thermosetting resin or the thermoplastic resin is used. The moisture curable resin can be used in either the 2P method or the 2T method, and is especially suitable for the formation of the structure 2 by the 2T method.

As the ionizing radiation curable resin, photopolymerizable prepolymer that can be cross-linked and cured by the irradiation with an ionizing radiation (UV ray or electron beam) can be used. As the photopolymerizable prepolymer, an acrylic-based prepolymer having two or more acryloyl groups in one molecule and having a three-dimensional reticular structure after the cross-linking and curing is particularly preferable for use. As the acrylic-based prepolymer, urethane acrylate, polyester acrylate, epoxy acrylate, melamine acrylate, polyfluoroalkyl acrylate, silicone acrylate, or the like can be used. These acrylic-based prepolymer can be used alone but a photopolymerizable monomer is preferably added for improving the cross-linking and curing property to further improve the hardness of the structure 2.

As a photopolymerizable monomer, one kind or two or more kinds of a single-functional acrylic monomer such as 2-ethylhexyl acrylate, 2-hydroxyethyl acrylate, 2-hydroxypropyl acrylate, or butoxyethyl acrylate, a 2-functional acrylic monomer such as 1,6-hexandiol diacrylate, neopentyl glycol diacrylate, diethylene glycol diacrylate, polyethylene glycol diacrylate, or hydroxy pivalate neopentyl glycol diacrylate, and a multi-functional acrylic monomer such as dipentaerythritol hexaacrylate, trimethylolpropane triacrylate, or pentaerythritol triacrylate can be used.

For the structure 2, the use of an additive such as a photopolymerization initiator or a photopolymerization promoter in addition to the photopolymerizable prepolymer and the photopolymerizable monomer mentioned above is preferable in the case of curing by the irradiation with a UV ray.

Examples of the photopolymerization initiator include acetophenone, benzophenone, Michler ketone, benzoin, benzylmethylketal, benzoyl benzoate, a-acyloxime ester, and thioxanthone.

The photopolymerization promoter is to accelerate the curing speed by reducing the polymerization troubles due to the air during the curing, and for example, p-dimethylaminobenzoic acid isoamyl ester, p-dimethylaminobenzoic acid ethyl ester, or the like is given.

As the ionizing radiation curable resin, an ionizing radiation curable type organic-inorganic hybrid resin is preferably used. Note that the ionizing radiation curable type organic-inorganic hybrid resin in the present invention refers to, differently from the conventional complex typified by glass fiber reinforced plastic (FRP), the one having sufficiently mixed organic and inorganic substances and the dispersion state equivalent to or close to a molecular level, and causing the inorganic and organic components react with each other under the irradiation with the ionizing radiation to form a film. As the inorganic component of such an ionizing radiation curable type organic-inorganic hybrid resin, a metal oxide such as silica or titania is given; the one including silica is particularly preferable.

Examples of the thermosetting resin include a silicone-based resin, a phenol-based resin, a urea-based resin, a melamine-based resin, a furan-based resin, an unsaturated polyester-based resin, an epoxy-based resin, a diallyl phthalate-based resin, a guanamine-based resin, a ketone-based resin, an aminoalkyd-based resin, a urethane-based resin, an acrylic-based resin, and a polycarbonate-based resin. Although these can be used alone, the addition of a curing agent is desirable for further improving the cross-linking property and the hardness of a film cross-linked and cured and formed by application (structure 2).

As the curing agent, a compound including polyisocyanate, an amino resin, an epoxy resin, a carboxylic acid, or the like can be used as appropriate in accordance with the resin used.

Examples of the thermoplastic resin include an ABS resin, a norbornene resin, a silicone-based resin, a nylon-based resin, a polyacetal-based resin, a polycarbonate-based resin, a modified polyphenylene ether resin, polybutylene terephthalate, polyethylene terephthalate, a sulfone-based resin, an imide-based resin, a fluorine-based resin, a styrene-based resin, an acrylic-based resin, a vinyl chloride-based resin, a vinyl acetate-based resin, a vinyl chloride-vinyl acetate copolymer-based resin, a polyester-based resin, a urethane-based resin, a nylon-based resin, a rubber-based resin, polyvinyl ether, polyvinyl alcohol, polyvinyl butyral, polyvinylpyrrolidone, and polyethylene glycol.

Among these thermosetting resins and thermoplastic resins, the thermosetting resin or thermoplastic resin of the acrylic-based resin is preferably used because the applied film strength and the favorable transparency of the structure 2 formed can be obtained. Moreover, the thermosetting resin or the thermoplastic resin can be used as a composite resin in which plural kinds of the thermosetting resins or plural kinds of the thermoplastic resins are combined.

The moisture curable resin is cured through reaction with moisture in the air; and for example, a one-component silicone resin, a one-component modified silicone resin, a one-component polyurethane resin, a two-component modified silicone resin, or the like is given. Such a moisture curable resin provides an advantage in that the structure 2 can be formed without using external energy such as light or heat that would be necessary in the case of using the ionizing radiation curable resin, the thermosetting resin, or the thermoplastic resin.

As the polymer resin included in the structure 2, a resin other than the aforementioned resins can be also used. As for the content proportion of the resin in the case where the polymer resin includes two or more kinds of resins, the ionizing radiation curable resin is preferably contained by 30 wt. % or more in the total polymer resin component in the case of the 2P method from the viewpoint of accurate production of the uneven layer 3 through the shape transfer technique. In the case of the 2T method or the emboss processing method, the thermosetting resin or the thermoplastic resin is preferably contained by 30 wt. % or more in the total polymer resin component.

Note that the structure 2 may contain, in addition to the polymer resin, various kinds of additives such as a lubricant, a fluorescent whitening agent, a microparticle, an antistatic agent, a fire retarder, an antibacterial agent, an antifungal agent, a UV ray absorber, a light stabilizer, an antioxidant, a plasticizer, a leveling agent, a fluid adjusting agent, an antifoam agent, a dispersing agent, a surface lubricant, a cross-linking agent, and the like, as long as those effects are not interrupted. Note that, as aforementioned, the microparticle herein described refers to the one having a particle diameter at a nanometer level but not the one having a particle diameter at a micrometer level used for the conventional anti-newton ring sheet.

The structure 2 of this embodiment is preferably formed using any of or a combination of a quadrangular pyramid and a solid of revolution whose vertical section has a substantial semicircle (including a substantially semi-perfect circle and a substantially semi-ellipsoid). By forming the structure 2 with such a quadrangular pyramid or a solid of revolution, the structural strength of the structure 2 formed into the anti-newton ring sheet can be increased. Note that the quadrangular pyramid may be either square or rectangular as long as the bottom part thereof is quadrangular.

In the anti-newton ring sheet 1 according to this embodiment, the plurality of structures 2 each formed as the aforementioned quadrangular pyramid or the solid of revolution may be mixedly provided, or the structures of any one kind may be provided. When only the quadrangular pyramids are used as these structures, the structures 2 (furthermore, the uneven layer 3) can be produced efficiently.

In this embodiment, as aforementioned, the height of the vertical section changes along the direction of the straight line connecting the peak Pa of the base structure 2a and the peaks Pb and Pc of the other structures 2b and 2c, and the change is made periodically. When the height of the vertical section of the uneven layer 3 changes periodically, glare can be prevented more suitably while newton's rings are prevented.

The change period of the height of the vertical section of the uneven layer 3 is preferably set in the range of 25 μm to 1000 μm. By setting the change period at 25 μm or more, glare can be more effectively prevented also to various displays with higher definition. By setting the change period at 1000 μm or less, the anti-newton ring property can be more effectively provided. Among these, the above effect can be obtained particularly when the change period of the height is set in the range of 100 μm to 700 μm, more preferably in the range of 200 μm to 500 μm. Note that the “change period of the height” in this embodiment refers to the period (distance between peaks) in which the peak height changes from the peak Pa of the base structure 2a to the peak (for example, Pb or Pc) of another structure (for example, 2b or 2c). As long as the change period of at least one of the height on the x axis and the height on the y axis of the uneven layer 3 is within the above range, it is in the scope of this embodiment. However, both the height on the x axis and the height on the y axis are preferably set in the above preferable range for the change period from the viewpoint of having excellent balance among the anti-newton ring property, the anti-glare property, and the durability.

The peak height of the structure 2 is preferably set in the range of 0.8 μm to 20 μm, and more preferably 1 μm to 10 μm. By setting the peak height at 0.8 μm or more, the anti-newton ring property can be made favorable. Moreover, by setting the peak height at 20 μm or less, glare can be suppressed effectively, and the durability and the handling property as the anti-newton ring sheet can be increased. The peak height of the structure 2 refers to the vertical distance (reference sign a in FIG. 3) from the bottom part of the structure 2 to the peak position, and the thickness of the part not provided with the uneven layer 3 (the portion denoted by reference sign 5 in FIG. 3) is not considered.

The absolute value of an intersection angle F (see FIG. 3) at a point (for example, reference sign Q in FIG. 3) where the bottom surface of the structure 2 intersects with a surface in contact with any point on a ridge line of the structure 2 is preferably within 4 degrees. Within such a range, glare can be suppressed effectively, and the durability of the anti-newton ring sheet can be made particularly excellent. Suitably, the absolute value is more preferably set in the range of 0.001 to 4 degrees.

The uneven layer 3 with the above structure can be formed using a die including a complementary structure with respect to the uneven pattern forming the uneven layer 3. A method for producing such a die is not particularly limited; for example, a die for molding (female die) can be obtained by forming a concave on a flat plate while the cutting depth is controlled, using a cutting tool with an end having a particular sectional shape according to a fine hole drilling technique. Alternatively, a die for molding (female die) can be produced using a convex in a particular shape formed on a flat plate according to a laser microproduction technique, which is used as a male die.

As depicted in FIG. 4 and FIG. 5, in the case of using the support 4, a glass plate, a plastic film, or the like with high transparency can be used as the support 4. As the glass plate, for example, a glass plate of oxide glass such as silicate glass, phosphate glass, or borate glass can be used. In particular, a glass plate of silicate glass such as silicic acid glass, silicate alkali glass, soda lime glass, potash lime glass, lead glass, barium glass, or borosilicate glass is preferable. As the plastic film, for example, polyethylene terephthalate, polybutylene terephthalate, polyethylene naphthalate, polycarbonate, polyethylene, polypropylene, polystyrene, triacetyl cellulose, acrylic, polyvinyl chloride, a norbornene compound, or the like can be used. A polyethylene terephthalate film which has been oriented, especially biaxially oriented, is suitably used because the mechanical strength and the dimension stability are excellent. The support 4 is preferably subjected to adhesion-increasing processing such as plasma processing, corona discharge processing, far UV ray irradiation processing, or undercoating adhesion-increasing processing.

The thickness of the support 4 is not particularly limited but may be selected as appropriate in accordance with the material used; in consideration of the handling property as an anti-newton ring sheet, the thickness is generally in the range of approximately 25 to 500 μm, and preferably in the range of approximately 50 to 300 μm.

As the method for forming the anti-newton ring sheets 1, 1b, and 1c according to this embodiment, a shape transfer technique such as the 2P method, the 2T method, or the emboss processing method can be used. For example, a die having a concave pattern that is complementary for a convex pattern requested is filled with a polymer resin or the like for forming the aforementioned structure 2, and the pattern is shaped and transferred; then, the polymer resin or the like is cured and separated from the die. Thus, the anti-newton ring sheet 1 incorporating the convex pattern is obtained. In the case of using the support 4, the die is filled with the polymer resin or the like and the support 4 is overlapped thereon; then, the polymer resin or the like is cured and separated off from the die. Thus, the anti-newton ring sheets 1b and 1c each provided with the uneven pattern on the support 4 can be obtained (see FIGS. 4 and 5).

Among the aforementioned shape transfer techniques, the 2P method is preferably employed from the viewpoint of relatively shortening the production time for the anti-newton ring sheet and suppressing the thermal deformation of the structure member by eliminating the heating and cooling. On the other hand, from the viewpoint of high flexibility of material selection for the structure member and process cost reduction, the 2T method is preferably employed.

As for the emboss processing method in which the formation is performed at normal temperature, a corner becomes gentle as compared with the uneven shape of a print (emboss roll) due to the elasticity of the polymer resin at the time of the formation. Thus, it is difficult to obtain the uneven shape of a desired size. Therefore, from the viewpoint of accurate formation of the desired uneven shape, the 2P method or the 2T method is more preferably employed.

As for a method for curing the polymer resin, in the case where the polymer resin is an ionizing radiation curable resin, the curing can be performed by the irradiation with an ionizing radiation. In the case where the polymer resin is a thermosetting resin, the curing may be performed by applying heat. Here, as the ionizing radiation, for example, a UV ray in a wavelength region of 100 to 400 nm, preferably 200 to 400 nm emitted from a superhigh-pressure mercury lamp, a high-pressure mercury lamp, a low-pressure mercury lamp, a carbon arc, a metal halide lamp, or the like, or an electron beam in a wavelength region of 100 nm or less emitted from an electron beam accelerator of a scanning type or a curtain type can be used. The heating temperature for the thermosetting resin is set in consideration of the kind of the resin, the thickness of the anti-newton ring layer, and the like, and is generally in the range of 80 to 200° C.

As for the strength of the applied film of the structure 2 after the polymer resin is cured, the strength is preferably of such a degree that a surface of the structure 2 has no tack. Moreover, the pencil hardness based on JIS K5400: 1990 is preferably HB or more. When the anti-newton ring sheet including the structure 2 having the strength of the applied film at the aforementioned degree is used for the touch panel, the structure 2 is not easily deformed and has excellent durability.

Further, in this embodiment, a hard coat layer may be provided on a surface of the anti-newton ring sheet 1 opposite to the surface provided with the uneven layer 3. With the structure having the uneven layer 3 on one surface and the hard coat layer on the other surface, the “warpage” of the anti-newton ring sheet can be prevented in addition to the crack preventive effect due to the provision of the hard coat layer; accordingly, the quality of a product having the anti-newton ring sheet integrated, such as a touch panel, can be kept high.

The hard coat layer includes a resin such as the ionizing radiation curable resin, the thermosetting resin, the thermoplastic resin, or the moisture curable resin. Among these, the ionizing radiation curable resin is particularly preferable because the hard coat property is easily exerted. These resins can be formed using a resin similar to the ionizing radiation curable resin, the thermosetting resin, the thermoplastic resin, or the moisture curable resin that can be used for the aforementioned structure 2.

The hard coat layer is desirably adjusted so as not to cause a crack after a steel wool #0000 with a load of 300 g or preferably 500 g is moved back and forth 10 times. With such adjustment, the necessary hard coat property can be secured.

The hard coat layer desirably has a pencil scratch hardness value (pencil hardness) adjusted to H or more, more preferably 2H or more, and much more preferably 3H or more. By adjusting the pencil scratch hardness value at a predetermined value or more, the crack on a surface of the hard coat layer can be prevented effectively. Note that the pencil scratch hardness value is measured by a method based on JIS K5400: 1990. The abrasion or hardness of the hard coat layer can be adjusted depending on the kind of the resin included in the hard coat layer, the condition of the curing, and the like.

The thickness of the hard coat layer is preferably 0.1 μm to 30 μm, more preferably 0.5 μm to 15 μm, and much more preferably 2 μm to 10 μm. By setting the thickness of the hard coat layer to 0.1 μm or more, the hard coat property can be made sufficient. By setting the thickness of the hard coat layer at 30 μm or less, the occurrence of curl or lack of hardness can be prevented easily.

The hard coat layer as described above is formed on a surface of the anti-newton ring sheet of the present invention, opposite to the surface provided with the uneven layer 3, in a manner that an application liquid for the hard coat layer is adjusted by mixing the resin such as the aforementioned ionizing radiation curable resin, and the additive, a diluting agent, or the like used as necessary, and the liquid is applied by a conventionally known coating method such as a bar coater, a die coater, a blade coater, a spin coater, a roll coater, a gravure coater, a flow coater, spraying, screen printing, or the like and dried as necessary, and then the ionizing radiation curable resin is cured by the irradiation with an ionizing radiation.

In the case where the uneven layer 3 is formed on the support 4, for example, either the hard coat layer or the uneven layer 3 may be formed first; for achieving favorable flatness of the anti-newton ring sheet, the uneven layer 3 is preferably formed first.

In the case where both the hard coat layer and the uneven layer 3 include the ionizing radiation curable resin, both of them can be formed by half-curing one layer, forming the other layer, and collectively curing the both layers completely. By employing such a method, the production efficiency can be improved.

The anti-newton ring sheet 1 according to the present invention has been described so far; an anti-newton ring uneven pattern 1a including only the uneven layer 3 according to the present invention where the base layer 5 and the support 4 are not provided as depicted in FIG. 7 is also applicable as another embodiment. Such an anti-newton ring uneven pattern 1a can be produced by separating the support 4 of the anti-newton ring sheet 1b as depicted in FIG. 4, for example.

Next, an embodiment of a touch panel according to the present invention will be described.

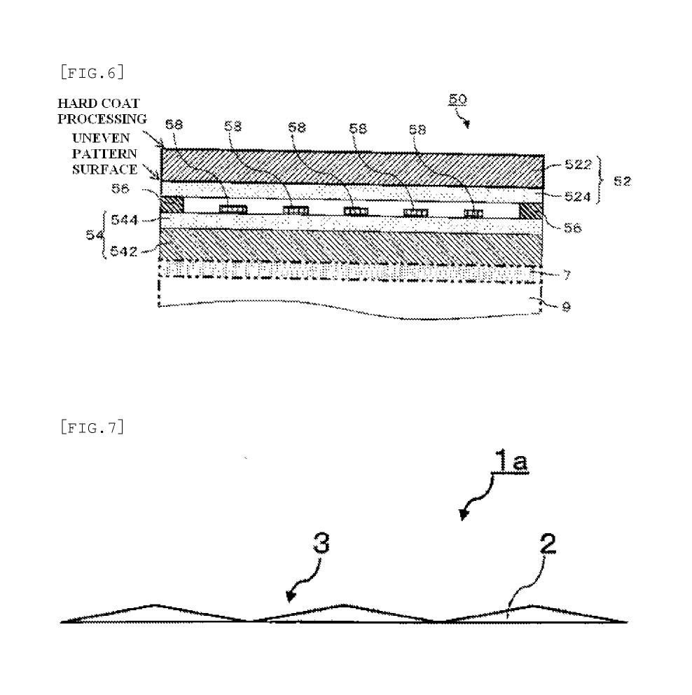

As depicted in FIG. 6, a touch panel 50 according to an embodiment of the present invention is of a resistance film type, which is attached to a front surface of a display element 9 such as liquid crystal provided for a variety of kinds of electronic appliances (such as a mobile phone or car navigation system). Through this touch panel 50, a letter, a symbol, a picture, or the like displayed on the display element 9 at the rear surface can be visually recognized and selected; by pressing with a finger, a special pen, or the like, the functions of the appliance can be switched.

The touch panel 50 of this embodiment includes an upper electrode substrate 52 and a lower electrode substrate 54. The upper electrode substrate 52 includes an upper transparent substrate 522 (panel plate), and a bottom surface of the upper transparent substrate 522 has an upper transparent conductive film (conductive film) 524. The lower electrode substrate 54 includes a lower transparent substrate 542 (panel plate) and a top surface of the lower transparent substrate 542 has a lower transparent conductive film (conductive film) 544.

The touch panel 50 may have a movable electrode on the upper electrode substrate 52 side or the lower electrode substrate 54 side; this embodiment exemplifies a case where the upper electrode substrate 52 is a movable electrode and the lower electrode substrate 54 is a fixed (unmovable) electrode.

Examples of the upper and lower transparent conductive films 524 and 544 include an inorganic, transparent, and conductive thin film of metal such as In, Sn, Au, Al, Cu, Pt, Pd, Ag, and Rh, metal oxide such as indium oxide, tin oxide, and ITO as a complex oxide including any of those, and an organic thin film of aromatic conductive polymer such as polyparaphenylene, polyacetylene, polyaniline, polythiophene, polyparaphenylene vinylene, polypyrrole, polyfuran, polyselenophene, and polypyridine.

As the upper transparent substrate 522 and/or the lower transparent substrate 542, the one similar to the support 4 specified in detail in the description of the aforementioned anti-newton ring sheet 1 or the aforementioned anti-newton ring sheet 1 can be used. In this case, one surface of the support 4 or the anti-newton ring sheet 1 is provided with the aforementioned transparent conductive films 524 and 544; when the inorganic thin film is employed, a vacuum film formation method such as a vacuum deposition method, a sputtering method, an ion plating method, or the like is used, and when the organic thin film is employed, a conventionally known coating method is used. Any hard coat processing is preferably performed on a surface to be touched of the upper transparent substrate 522 and/or the lower transparent substrate 542 as the panel plate.

In this embodiment, outer peripheral portions of the bottom surface of the upper electrode substrate 52 and the top surface of the lower electrode substrate 54 are attached to each other via a spacer 56 having substantially a frame shape. The upper transparent conductive film 524 of the upper electrode substrate 52 and the lower transparent conductive film 544 of the lower electrode substrate 54 are provided to face each other with a predetermined space therebetween. On the top surface of the lower transparent conductive film 544, spacers 58 are arranged in a dot-form at predetermined intervals as necessary. Note that the spacers 58 are disposed as necessary and a structure not having the spacers 58 is also applicable.

When a pair of panel plates is formed, the dot-form spacers 58 secure the space between the panel plates, control the weight upon touch, and facilitate the separation between the panel plates after the touch. The spacers 58 is generally formed using a transparent ionizing radiation curable resin, in a fine dot form through a photo-process. Alternatively, the spacers 58 can be formed by printing a large number of microscopic dots using a urethane-based resin or the like by a printing method such as silk screen. Further alternatively, the spacers 58 can be formed by spraying or applying a particle dispersion liquid including an inorganic substance or an organic substance, and drying the liquid. Although the size of the spacer 58 depends on the size of the touch panel, the spacer 58 generally has a diameter of 30 to 100 μm and a height of 1 to 15 μm, and is formed in a dot format a constant interval of 0.1 to 10 mm.

Each end of the upper and lower transparent conductive films 524 and 544 has a pair of electrodes (not depicted). In this embodiment, a pair of upper electrodes (not depicted) provided to the upper transparent conductive film 524 and a pair of lower electrodes (not depicted) provided to the lower transparent conductive film 544 are arranged in a direction so as to intersect with each other.

In this embodiment, a separator (not depicted) may be attached to the bottom surface of the lower electrode substrate 54 via an adhesive layer 7.

For mounting the touch panel 50 according to this embodiment to the front surface of the display element 9 of color liquid crystal or the like, first, the separator (not depicted) of the touch panel 50 according to this embodiment is separated off to expose the adhesive layer 7; then, the adhesive layer 7 is brought into contact with and face the front surface of the display element 9. Thus, the touch panel-equipped color liquid crystal display element can be formed.

In this touch panel-equipped color liquid crystal display element, when a user presses the top surface of the upper electrode substrate 52 with a finger, a pen, or the like while observing the display on the display element 9 arranged on the rear surface of the touch panel 50, the upper electrode substrate 52 is bent to bring the upper transparent conductive film 524 at the pressed position into contact with the lower transparent conductive film 544. By electrically detecting the pair of upper and lower electrodes that are in contact with each other, the pressed position is detected.

In this embodiment, the upper transparent substrate 522 of the upper electrode substrate 52 as the movable electrode is formed using the anti-newton ring sheet 1 of this embodiment (FIGS. 1 to 3), and the upper transparent conductive film 524 is made in contact with the surface of the anti-newton ring sheet 1 provided with the uneven layer 3.

Note that the upper transparent substrate 522 can be formed using the anti-newton ring sheet according to another embodiment (for example, the one depicted in FIG. 4, 5, or 7), in which case, similarly, the upper transparent conductive film 524 is made in contact with the surface of the anti-newton ring sheet provided with the uneven layer 3.

In this embodiment, the lower transparent substrate 542 of the lower electrode substrate 54 as the fixed electrode is formed using, for example, glass.

In this embodiment, in a manner similar to the upper electrode substrate 52, the lower transparent substrate 542 of the lower electrode substrate 54 can be formed using the anti-newton ring sheet 1 of this embodiment, and the lower transparent conductive film. 544 can be made in contact with the surface of the anti-newton ring sheet 1 provided with the uneven layer 3.

In this manner, the touch panel 50 including the anti-newton ring sheet 1 of this embodiment does not cause sparkle and glare on a color screen even in various displays that have come to have higher definition recently. Therefore, there can be provided the touch panel that does not deteriorate the visibility of the display. Moreover, since the anti-newton ring sheet has high durability, the touch panel has excellent durability period.

Note that when the anti-newton ring sheet 1 is integrated into the touch panel 50, the flow direction of the peak ridge line of the structure 2 in the uneven layer 3 of the anti-newton ring sheet 1 may be unparallel to and displaced from the arrangement direction of the regular structure of a liquid crystal panel or the like having the regular structure (the angle at the intersection between extension lines of the both directions is in the range of 5 to 95°). Such a structure can suitably prevent the moire that would be caused by the combination between the anti-newton ring sheet 1 and the liquid crystal panel having the regular structure or the like.

### EXAMPLES

The present invention will be further described hereinafter with Examples. Note that “part” and “%” are based on weight unless otherwise specified.

1. Production of Anti-Newton Ring Sheet

### Example 1

A mold was produced by cutting a 4-mm-thick copper plate having a smooth surface with a carving diamond bit. Into the produced mold, a mixture liquid including 50 parts of an acrylic monomer (methacrylic acid methyl: Wako Pure Chemical Industries, Ltd.) as the UV ray curable resin, 45 parts of a multi-functional acrylic monomer (NK-ESTER A-TMPT-3EO: Shin-Nakamura Chemical Co., Ltd.), and 5 parts of a photopolymerization initiator (IRGACURE 184: Ciba Japan K.K.) was dropped, and a 100-μm-thick polyester film (COSMOSHINE A4300: TOYOBO CO., LTD.) was overlapped thereon and the resin was spread out uniformly with a roller so as not to leave air bubbles. Thus, the resin and the polyester film were brought into close contact with each other.

In this state, a UV ray with 1500 mJ/cm² from a metal halide lamp was delivered from the polyester film side to cure the UV ray curable resin; then, the polyester film and the resin were separated from the mold. Thus, the anti-newton ring sheet according to Example 1 to which the shape of the mold has been faithfully transferred (the structure shown in FIG. 5) was produced. Table 1 represents the specifications of the structure in the uneven layer of the anti-newton ring sheet of Example 1.

### Examples 2 to 10

Anti-newton ring sheets of Examples 2 to 10 were produced in a manner similar to the sheet of Example 1 except that the copper plate was cut under a condition different from Example 1. Table 1 represents the specifications of the structures in the uneven layers of the anti-newton ring sheets of Examples 2 to 10.

### Comparative Example 1

An anti-newton ring sheet of Comparative Example 1 was produced by forming a 2-μm-thick uneven layer (anti-newton ring layer) in a manner that an application liquid shown in the prescription below for the anti-newton ring layer was applied and dried on one surface of a polyester film similar to that of Example 1 as a support and then, the irradiation with a UV ray from a high-pressure mercury lamp was performed.

### <Prescription of Application Liquid for Anti-Newton Ring Layer of Comparative Example 1>

| | |
|---|---|
| Ionizing radiation curable resin (solid content 100%) | 50 parts |
| (BEAM SET 575: Arakawa Chemical Industries, | |
| Ltd.) | |
| Microparticle (acrylic-based resin particle) | 0.4 parts |
| (average particle diameter 3 μm) | |
| photopolymerization initiator | 1.5 parts |
| (IRGACURE 651: Ciba Japan K.K.) | |
| Isopropyl alcohol | 200 parts |

### Comparative Examples 2 to 4

An anti-newton ring sheet of Comparative Example 2 was produced in a manner similar to the sheet of Example 1 except that the copper plate was cut under a condition different from Example 1. Table 1 represents the specifications of the structures in the uneven layers of the anti-newton ring sheets of Comparative Examples 2 to 4.

Note that the structure of each of Comparative Examples 2 to 4 has a quadrangular or triangular prism shaped with no change in peak height, having a quadrangular or triangular vertical section. A space (distance) exists between the structures.

TABLE 1

| | Specifications of structure | | | | | |
|---|---|---|---|---|---|---|
| | | Change period of height | | Absolute value | Peak | Distance between |
| | | On x axis | On y axis | of intersection | height | structures |
| | Shape | (μm) | (μm) | angle (°) | (μm) | (μm) |
| Example 1 | Quadrangular | 480 | 480 | 0.7 | 3 | Substantially |
| | pyramid | | | | | zero |
| Example 2 | Quadrangular | 220 | 220 | 1.6 | 3 | Substantially |
| | pyramid | | | | | zero |
| Example 3 | Quadrangular | 30 | 30 | 3.1 | 0.8 | Substantially |
| | pyramid | | | | | zero |
| Example 4 | Quadrangular | 990 | 990 | 1.2 | 10 | Substantially |
| | pyramid | | | | | zero |
| Example 5 | Quadrangular | 24 | 24 | 3.8 | 0.8 | Substantially |
| | pyramid | | | | | zero |
| Example 6 | Quadrangular | 1500 | 1500 | 0.8 | 10 | Substantially |
| | pyramid | | | | | zero |
| Example 7 | Quadrangular | 480 | 480 | 4.5 | 19 | Substantially |
| | pyramid | | | | | zero |
| Example 8 | Solid of | 480 | 480 | 2.4 | 10 | Substantially |
| | revolution | | | | | zero |
| Example 9 | Solid of | 30 | 30 | 3.1 | 1 | Substantially |
| | revolution | | | | | zero |
| Example 10 | Quadrangular | 480 | 1500 | 0.7 | 3 | Substantially |
| | pyramid | | | (on x axis) | | zero |
| | | | | 0.23 | | |
| | | | | (on y axis) | | |
| Comparative | Unspecified | Unspecified | Unspecified | 6 | 2 | Unspecified |
| Example 1 | | | | | | |
| Comparative | Quadrangular | 50 | Unvaried | — | 5 | 40 |
| Example 2 | prism | | | | | |
| Comparative | Quadrangular | 480 | Unvaried | — | 5 | 470 |
| Example 3 | prism | | | | | |
| Comparative | Triangular | 50 | Unvaried | — | 20 | 470 |
| Example 4 | prism | | | | | |

“Solid of revolution” in the Table refers to a solid of revolution whose vertical section is a substantial semicircle. Moreover, “absolute value of intersection angle” refers to an absolute value of an intersection angle (β in FIG. 3) at a position where a bottom surface of the structure intersects with a surface in contact with any point on a ridge line of the structure.

Furthermore, “distance between structures” refers to, in Examples 1 to 10, the distance between the adjacent structures on the x axis and the y axis when the structures are arranged in a lattice-like formation, and refers to, in Comparative Examples 2 to 4, the distance between the structure rows. Moreover, “substantially zero” refers to the distance of substantially zero excluding the space (error) of approximately several micrometers which may be formed in the work of mold cutting.

### 2. Production of Touch Panel

### (1) Production of Panel Plate for Upper Electrode

A conductive film of ITO with a thickness of approximately 20 nm was formed by a sputtering method on the anti-newton ring layer (uneven layer) of the anti-newton ring sheet in each of the above examples, a hard coat film (KB film N05S: KIMOTO CO., LTD.) was attached to the other surface with an adhesive, then to be cut into a 4-inch size (a rectangle with a vertical length of 87.3 mm and a horizontal length of 64.0 mm), thereby producing the panel plate for the upper electrode.

### (2) Production of Panel Plate for Lower Electrode

A conductive film of ITO with a thickness of approximately 20 nm was formed by a sputtering method on one surface of a 1-mm-thick reinforced glass plate as a support and was cut into a 4-inch size (a rectangle with a vertical length of 87.3 mm and a horizontal length of 64.0 mm), thereby producing the panel plate for the lower electrode.

### (3) Production of Spacer

An ionizing radiation curable resin (Dot Cure TR5903: (TAIYO INK MFG. CO., LTD.) as an application liquid for spacers was printed in a dot-form by a screen printing method on a surface of the panel plate for the lower electrode provided with the conductive film, and then irradiation with a UV ray from a high-pressure mercury lamp was performed, so that spacers with a diameter of 50 μm and a height of 8 μm were arranged at an interval of 1 mm.

### (4) Production of Touch Panel

The panel plate for the upper electrode and the panel plate for the lower electrode were disposed so that the conductive films of the panel plates faced each other. Then, in order for the attached portion to be formed outside a region of a display surface, the edges were attached to each other with a double-sided adhesive tape with a thickness of 30 μm and a width of 3 mm. Thus, the touch panel of each example was produced.

### 3. Evaluation

### (1) Anti-Newton Ring Property of Anti-Newton Ring Sheet

The surface of the anti-newton ring sheet provided with the uneven layer obtained in each example was pressed with a finger so that the surface is in contact with the smooth glass plate, and whether or not newton's rings occurred was evaluated through visual observation. The results of the evaluation are expressed in Table 2 in which the one having no newton's rings is represented by “Excellent”, the one having a very small amount of newton's rings but having no influence on the visibility at all is represented by “Good”, the one having a small amount of newton's rings but having not deteriorated the visibility is represented by “Acceptable”, and the one having newton's rings and having deteriorated the visibility is represented by “Poor”.

### (2) Anti-Glare Property of Touch Panel

A 100%-green image was displayed on a display screen of a CRT display including the touch panel of each example, and the evaluation was made through visual observation with the lower electrode side of the touch panel being in close contact with the display screen. The results of the evaluation are expressed in Table 2 in which the one having no glare is represented by “Excellent”, the one having almost no glare is represented by “Good”, the one having a little glare is represented by “Acceptable”, the one having clear glare is represented by “Poor”, and the one having remarkable glare is represented by “Bad”.

### (3) Durability of Touch Panel

The touch panel in each example was pressed 100,000 times with a stylus pen at a pressure of 2.5 N/mm². Then, whether the touch panel had newton's rings or not was checked through visual observation. The results of the evaluation are expressed in Table 2 in which the one having no newton's rings is represented by “Excellent”, the one having a very small amount of newton's rings but having no influence on the visibility at all is represented by “Good”, the one having a small amount of newton's rings but having not deteriorated the visibility is represented by “Acceptable”, the one having newton's rings and having deteriorated the visibility is represented by “Poor”, and the one having newton's rings and having remarkably deteriorated the visibility is represented by “Bad”.

TABLE 2

| | Anti-newton | Anti-glare | |
|---|---|---|---|
| | ring property | property | Durability |
| Example 1 | Excellent | Excellent | Excellent |
| Example 2 | Excellent | Excellent | Excellent |
| Example 3 | Excellent | Good | Excellent |
| Example 4 | Good | Excellent | Excellent |
| Example 5 | Excellent | Acceptable | Excellent |
| Example 6 | Acceptable | Excellent | Excellent |
| Example 7 | Excellent | Acceptable | Good |
| Example 8 | Excellent | Excellent | Excellent |
| Example 9 | Excellent | Good | Excellent |
| Example 10 | Acceptable | Excellent | Excellent |
| Comparative | Excellent | Bad | Excellent |
| Example 1 | | | |
| Comparative | Good | Good | Poor |
| Example 2 | | | |
| Comparative | Acceptable | Excellent | Bad |
| Example 3 | | | |
| Comparative | Good | Good | Bad |
| Example 4 | | | |

As is clear from the results in Table 2, the anti-newton ring sheets of Examples 1 to 10 each includes the uneven layer formed by arranging the plurality of structures in a lattice-like formation without any space and each of the structures is substantially formed with the polymer resin. The structure has a peak, and the height of the vertical section of the uneven layer on the straight line connecting the peak of any of the structures and the peaks of other structures existing on the x axis and the y axis of the any structure changes periodically. Therefore, the anti-newton ring property was excellent. The touch panels of Examples 1 to 10 each including this sheet did not experience sparkle and glare on a color screen even in the use for a CRT color display, so that the visibility of the display did not deteriorate. Moreover, the durability was excellent.

In particular, the change period of the height of the vertical section of the anti-newton ring sheet of each of Examples 1 to 4 and 7 to 9 is in the range of 25 to 1000 μm; therefore, the balance between the anti-newton ring property and the anti-glare property was particularly excellent except for the anti-glare property of the anti-newton ring sheet of Example 7. Among these, since the anti-newton ring sheets of Examples 1, 2, 7, and 8 have the change period in the range of 200 to 500 μm, both the anti-newton ring property and the anti-glare property were particularly excellent except for the anti-glare property of the anti-newton ring sheet of Example 7.

Moreover, since the anti-newton ring sheet of Example 10 has the change period of the sectional height on the x axis in the range of 200 to 500 μm, the anti-glare property was particularly improved. Note that, however, the change period of the sectional height on the y axis is more than 1000 μm, with the result that the anti-newton ring property was in the same degree as that of Example 6. That is, as compared with the anti-newton ring sheet of Example 1, the balance between the anti-newton ring property and the anti-glare property was poor.

When the anti-newton ring sheets of Example 10 and Example 6 were compared, the both had the same change period of the sectional height on the y axis, but the sheet of Example 10 had a shorter change period on the x axis. Therefore, the sheet of Example 10 had more peaks on the x axis and had more supporting points for a counter member. As a result, the sheets of Examples 6 and 10 had both excellent durability, but the sheet of Example 10 was superior to that of Example 6 in durability.

In addition, the absolute value of the intersection angle at a position where the bottom surface of the structure and the surface in contact with any point on the ridge line of the structure of the anti-newton ring sheet of each of Examples 1 to 6 and 8 to 10 was within 4 degrees; therefore, the touch panels of Examples 1 to 6 and 8 and 9 each including the anti-newton ring sheet had particularly excellent durability.

Meanwhile, the anti-newton ring sheet of Comparative Example 1 contains microparticles in addition to the polymer resin in the anti-newton ring layer and the uneven shape on the surface of the anti-newton ring layer was formed by means of the microparticles. Therefore, the anti-newton ring property was exerted, however, when the anti-newton ring sheet was used as the member of the touch panel, the microparticles existing in the anti-newton ring layer served as bright points to cause sparkle, thereby drastically lowering the anti-glare property.

The anti-newton ring sheet of each of Comparative Examples 2 to 4 had a quadrangular or triangular prism shaped with no change in peak height along a flow direction of the peak ridge line, having a quadrangular or triangular vertical section, as the structure that forms the uneven layer. Moreover, since the structures were formed at predetermined intervals instead of being formed with no space therebetween, the touch panel of each of Comparative Examples 2 to 4 including the anti-newton ring sheet experienced newton's rings through the repetitive use, thereby having low durability.

1. An anti-newton ring sheet having an uneven layer, wherein:
the uneven layer is substantially formed with a polymer resin by arranging a plurality of structures with peaks in a lattice-like formation; and
when, in a plan view of the sheet, an axis extending in one arrangement direction of the structures is an x axis, an axis extending in a direction orthogonal to the x axis is a y axis, an arbitrarily defined structure from among all the structures forming the uneven layer is a base structure, and the structures adjacent to this base structure on both the x axis and the y axis are other structures,
the uneven layer has a vertical section height changing periodically along a straight line direction connecting the peak of the base structure and the peaks of the other structures.

2. The anti-newton ring sheet according to claim 1, wherein
a change period of the height is 25 μM to 1000 μM.

3. The anti-newton ring sheet according to claim 1, wherein
an absolute value of an intersection angle at a position where a bottom surface of the structure intersects with any point on a ridge line of the structure is within 4 degrees.

4. The anti-newton ring sheet according to claim 3, wherein
the structure is formed with only the polymer resin with no microparticle.

5. The anti-newton ring sheet according to claim 4, wherein
a hard coat layer is provided on a surface opposite to the surface provided with the uneven layer.

6. A method for producing the anti-newton ring sheet according to claim 5, wherein:
an ionizing radiation curable resin is used as the resin included in the both of the uneven layer and the hard coat layer; and
while one of the layers is half-cured, the other layer is formed, and the both layers are collectively cured completely.

7. A resistance film type touch panel formed by disposing a pair of panel plates each having a conductive film so that the conductive films face each other via a spacer, wherein
one or both of the conductive films are formed on the surface provided with the uneven layer of the anti-newton ring sheet according to claim 5.

8. The anti-newton ring sheet according to claim 1, wherein
an absolute value of an intersection angle at a position where a bottom surface of the structure intersects with any point on a ridge line of the structure is within 4 degrees.

9. The anti-newton ring sheet according to claim 1, wherein
the structure is formed with only the polymer resin with no microparticle.

10. The anti-newton ring sheet according to claim 2, wherein
the structure is formed with only the polymer resin with no microparticle.

11. The anti-newton ring sheet according to claim 1, wherein
a hard coat layer is provided on a surface opposite to the surface provided with the uneven layer.

12. The anti-newton ring sheet according to claim 2, wherein
a hard coat layer is provided on a surface opposite to the surface provided with the uneven layer.

13. The anti-newton ring sheet according to claim 3, wherein
a hard coat layer is provided on a surface opposite to the surface provided with the uneven layer.

14. A method for producing the anti-newton ring sheet according to claim 11, wherein:
an ionizing radiation curable resin is used as the resin included in the both of the uneven layer and the hard coat layer; and
while one of the layers is half-cured, the other layer is formed, and the both layers are collectively cured completely.

15. A method for producing the anti-newton ring sheet according to claim 12, wherein:
an ionizing radiation curable resin is used as the resin included in the both of the uneven layer and the hard coat layer; and
while one of the layers is half-cured, the other layer is formed, and the both layers are collectively cured completely.

16. A method for producing the anti-newton ring sheet according to claim 13, wherein:
an ionizing radiation curable resin is used as the resin included in the both of the uneven layer and the hard coat layer; and
while one of the layers is half-cured, the other layer is formed, and the both layers are collectively cured completely.

17. A resistance film type touch panel formed by disposing a pair of panel plates each having a conductive film so that the conductive films face each other via a spacer, wherein
one or both of the conductive films are formed on the surface provided with the uneven layer of the anti-newton ring sheet according to claim 1.

18. A resistance film type touch panel formed by disposing a pair of panel plates each having a conductive film so that the conductive films face each other via a spacer, wherein
one or both of the conductive films are formed on the surface provided with the uneven layer of the anti-newton ring sheet according to claim 2.

19. A resistance film type touch panel formed by disposing a pair of panel plates each having a conductive film so that the conductive films face each other via a spacer, wherein
one or both of the conductive films are formed on the surface provided with the uneven layer of the anti-newton ring sheet according to claim 3.

20. A resistance film type touch panel formed by disposing a pair of panel plates each having a conductive film so that the conductive films face each other via a spacer, wherein
one or both of the conductive films are formed on the surface provided with the uneven layer of the anti-newton ring sheet according to claim 4.
